(19) United States
(12) Patent Application Publication
(10) Pub. No.: US 2007/0150458 A1
(43) Pub. Date: Jun. 28, 2007

(54) System for extending data query using ontology, and method therefor

(75) Inventors: Myung Guen Chung, Incheon-city (KR); Myung Eun Lim, Daejeon-city (KR); Myung Nam Bae, Daejeon-city (KR); Seon Hee Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/635,446

(22) Filed: Dec. 7, 2006

(30) Foreign Application Priority Data
Dec. 8, 2005 (KR) 10-2005-0119470
Jul. 26, 2006 (KR) 10-2006-0070293

(51) Int. Cl. G06F 17/30

(52) U.S. Cl. 707/3

(57) ABSTRACT

Provided are an information query extension system and method, and more particularly, a method for efficiently managing heterogeneous data using a defined specification language to represent information distributed on the Internet, and extending a conceptual query which is a criteria for integration for a specific purpose.

### CROSS-REFERENCE TO RELATED PATENT APPLICATION

This application claims the benefit of Korean Patent Application No. 10-2005-0119470, filed on Dec. 8, 2005 and Korean Patent Application No. 10-2006-0070293, filed on Jul. 26, 2006, in the Korean Intellectual Property Office, the disclosures of which are incorporated herein in their entireties by reference.

### BACKGROUND OF THE INVENTION

1. Field of the Invention

The present invention relates to a database integration technique, and more particularly, to an information query extension system and method for acquiring desired information from information resources having different formats and stored in different locations.

2. Description of the Related Art

Many requirements for integration of biological information are in the field of molecular biology and genetics. Pharmaceutical companies require integration of 40 biology databases on the average. In order to integrate data of distributed heterogeneous sources, techniques, such as “Data Warehouse”, “Data Mart”, “Mediator-wrapper”, etc., have been developed. These techniques are aimed at giving “semactic” to legacy data and providing an integrated view of information.

However, the techniques, such as the data warehouse, the data mart, etc., have low adaptability with respect to dynamic changes in data, and, in many cases, the wrapper-arbitrator model does not propose a general approach using shared languages for data access.

Also, the conventional techniques are more or less insufficient for representing coherence between databases which biology information data has.

Actually, when users integrate heterogeneous databases, the conventional techniques have many limitations in maintenance, repair, use of data. Most of the limitations exist in that the databases are established in a local form and queries are limited.

When the databases are integrated in the local form, a problem exists in that established resources change momentarily. In a case of a “Gene-ontology” database, an upgrade is performed every 30 minutes, which is not efficient for an integration system.

Considering the limitation in queries, since conventional data utilizes a SQL-based ‘relational database’, the data must be stored in a table form. Accordingly, users must have some knowledge related to the schema of the entire database, and also queries are processed in a very complicated manner.

Users want to use remote data or personal data through an integrated view, together with data control, data analysis, and visualization means with a more developed type.

Recently, due to the development of network techniques and the activation of the Internet, various mass information is provided. Particularly, in biological information, as a gene sequence is revealed after the Human Genome Project is complete, various biological researches have been performed, and as a result, various products are established as databases and provided in various forms on the web.

However, due to the volume and variety of information, information users have difficulties in properly finding their desired information and must spend much time and efforts for information acquirement. Also, according to the conventional method, users must have some technical knowledge in order to process data into information with a desired format, between heterogeneous sources, and acquire the processed data as an integrated form.

### SUMMARY OF THE INVENTION

The present invention provides an ontology-based information query extension system and method for acquiring desired information from information resources distributed and stored with different forms in different locations, based on ontology.

According to an aspect of the present invention, there is provided an information query extension system including: a query processor receiving a query for desired information, from a user, and classifying the query into a local query for each of a plurality of distributed information databases; a wrapper management unit managing at least one base wrapper for executing the local query and transferring the executed local query result to the query processor; and an ontology management unit classifying an ontology processing query if the ontology processing query exists in the query, transferring the classified ontology processing query to the at least one base wrapper, receiving an executed local query result of the at least one base wrapper from the wrapper management unit, and reflecting the query executed result with the query.

According to another aspect of the present invention, there is provided an information query extension method including: (a) receiving a query for desired information from a user and classifying the query into a local query for each of a plurality of distributed information databases; (b) executing the classified local query using at least one base wrapper; and (c) if an ontology processed query exists in the query, classifying the ontology processed query, transferring the classified query to the at least one base wrapper, and reflecting the executed query result of the at least one base wrapper with the query.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of an ontology-based information query extension system according to an embodiment of the present invention;

FIG. 2 illustrates a structure of an ontology-based query processing apparatus according to an embodiment of the present invention;

FIG. 3 is a flowchart illustrating ontology-based query extension method according to an embodiment of the present invention;

FIG. 4 illustrates an ontology-based query extension rule table according to an embodiment of the present invention; and

FIG. 5 is a view for explaining a gene-ontology-based XQuery query extension method according to an embodiment of the present invention.

### DETAILED DESCRIPTION OF THE INVENTION

Hereinafter, an ontology-based information query extension system and method according to an embodiment of the present invention will be described in detail with reference to the appended drawings.

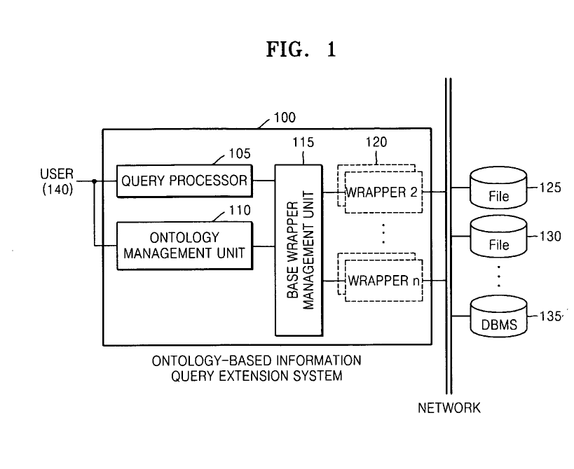

FIG. 1 illustrates a structure of an ontology-based information query extension system according to an embodiment of the present invention.

Referring to FIG. 1, the ontology-based information query extension system 100 includes a query processor 105, an ontology management unit 110, a base wrapper management unit 115, and a plurality of wrappers 120. The respective wrappers 120 are connected to heterogeneous databases 125, 130, and 135, through a network.

If a user query is provided through a user interface (not shown), the query processor 105 analyzes and classifies the user query into a local query, and then transfers the results to the respective wrappers 120 for extracting data from the databases 125, 130, and 135.

The base wrapper management unit 115 manages the wrappers 120 for executing the classified local query and transfers the query execution results of the wrappers 120 to the query processor 105.

The ontology management unit 110 analyzes the user query when a query requiring ontology processing exists in the user query, and transfers the query to the respective wrappers 120. The respective wrappers 120 execute the query with respect to various data sources, such as relational databases or files which can be obtained from the Web or exists in a local location, obtain an XML-based document, and transfer the XML-based document to the ontology management unit 110. The ontology management unit 110 transfers the XML-based document to the query processor 105 and reflects the corresponding content to an existing query, thereby completing query processing.

The present invention can be used regardless of the formats (HTML, FILE, DBMS, etc.) of ontology resources. The ontology management unit 110 integrates the processed results generated by the respective base-type wrappers 120 and provides the processed results to the query processor 105.

A user can define data items to be extracted for a specific data source using ontology, and acquire resources for integration through various functions regarding the defined data items. If an ontology function exists in the query, the ontology management unit 110 performs a function through ontology using the base-type wrappers 120 when processing the corresponding query, and reflects the function result to the query.

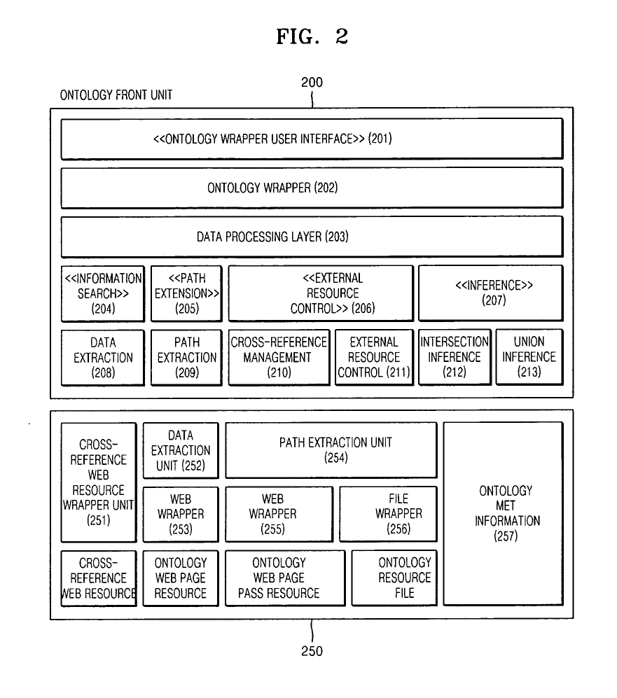

FIG. 2 shows the structure of an ontology-based ontology management unit 110 according to an embodiment of the present invention.

A user wants to integrate two or more databases or resources according to his or her purpose. However, since resources are stored with different forms in different locations, various limitations exist. In order to avoid such limitations, the ontology management unit 110 includes two stages: an upper stage and a lower stage.

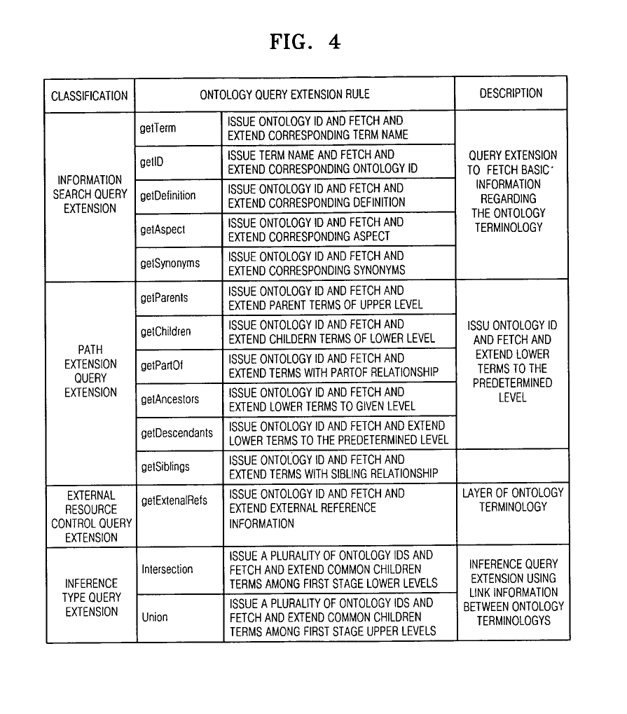

The upper stage is an ontology front part 200. The ontology front part 200 performs ontology-related functions. The ontology front part 200 includes an ontology wrapper user interface 201 for allowing an actual user to use the ontology. The ontology wrapper user interface 201 will be described in detail later with reference to FIG. 4.

If a user calls the ontology wrapper user interface 201, a series of operations for driving an ontology function are performed. For example, a process of finding an ontology file and loading the ontology file in an actual instance is performed. Here, the process is performed in the ontology wrapper 202.

The ontology wrapper 202 participates in object creation and deletion. The ontology wrapper 202 can refer to two or more layers, and particularly, can use a plurality of resources, when a function, such as external resource control 206, etc., is performed. Accordingly, actual data has a unique data processing layer.

Substantially, functions of ontology include four cases; a determination on whether a user uses base ontology, a determination on whether a query is searched in the ontology, a determination on whether a cross-reference document is controlled in the ontology, and a determination on whether an inference calculation can be performed in the ontology.

An information search interface 204 for processing information regarding base ontology items is provided to execute a data extraction function 208 of a base wrapper. A path extension interface 205 is provided to execute a path extraction function 209 and the data extraction function 208. An external resource control interface 206 is provided to execute a cross-reference management function 210 for finding actual related-information using references, an actual data extraction function 208, and a controllable external resource control function 211. Also, an inference interface 207 is configured to allow base inferences, such as intersection inference 212 and union inference 213, etc.

The lower stage is a base wrapper rear part 250. The base wrapper rear part 250 has a form into which functions of base wrappers are collected, and must include an Open Biological Ontology (OBO) consortium standard. For that, the base wrapper rear part 250 manages ontology meta information.

Ontology must include a function of extracting data and a function of searching for a navigation route between ontology. A data extraction unit 252 and a path extraction unit 254 perform the data extraction function 208 and the path search function 209, respectively. Basically, since ontology uses a file with a web or local format, information is extracted through two web wrappers 253 and 255 and a file wrapper 256. Accordingly, the web wrapper 253 is assigned to the data extraction unit 252. Actually, since the ontology wrapper 202 has high probability of using a user file at a local location in order to ensure flexibility of the corresponding system, the path extraction unit 254 is configured to simultaneously use the web wrapper 255 and the file wrapper 256. Finally, a web resource wrapper 251 for cross-reference is configured so that an external resource is directly available.

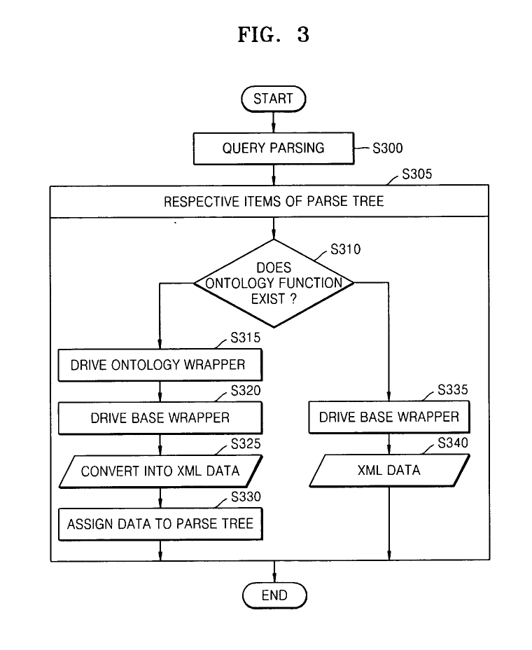

FIG. 3 is a flowchart illustrating an ontology-based query extension method according to an embodiment of the present invention.

Referring to FIG. 3, first, an information query extension system (hereinafter, simply referred to as a “system”) performs parsing for query extension (operation S300). The system stores the parsed result in a parse tree which is a tree-type query storage format. The system analyzes respective items while traveling a pre-stored parse tree (operation S305).

Each of the items includes a junction for processing an ontology item, separately from processing in a base wrapper. The system circulatedly searches for the parse tree including such junctions, etc., and determines whether each item is an ontology wrapper (operation S310).

If an ontology function exists in a predetermined item of the parse tree (operation S310), the system drives a query wrapper in which the ontology function is included (operation S315), and calls the corresponding function (operation S320). The ontology wrapper may be a base wrapper. The system executes query processing when XQuery is performed, and obtains the corresponding data in an XML format (operation S325). The system assigns the corresponding result to the query processed result of the parse tree (operation S330).

If no ontology function exists in the predetermined item of the parse tree, the system drives a base wrapper (operation S335), generates XML data, and directly returns the XML data to the query processor (operation S340).

FIG. 4 illustrates an ontology-based query extension rule table according to an embodiment of the present invention.

In the current embodiment, four ontology-based extension methods are proposed. The term “ontology” is derived from the Greek language “Ontos (being)” and “logos (word)”. Accordingly, the ontology is a study for researching “being” and “a range of being”. The ontology can be used as a synonym of a “Tanxonomy” for classifying concept types or ranges in a knowledge database.

The ontology-based query extension methods include four ontology-based query extension methods: information search, path extension, external resource control, and inference.

The path extension is query extension through path search extended using layer information.

The external resource control extends query through cross-reference control with relationship between information, due to the development of the Internet.

The inference allows a query to implement functions of intersections and unions of information on ontology. Referring to FIG. 4, detailed items of the respective extension methods refer to the corresponding query extension rules.

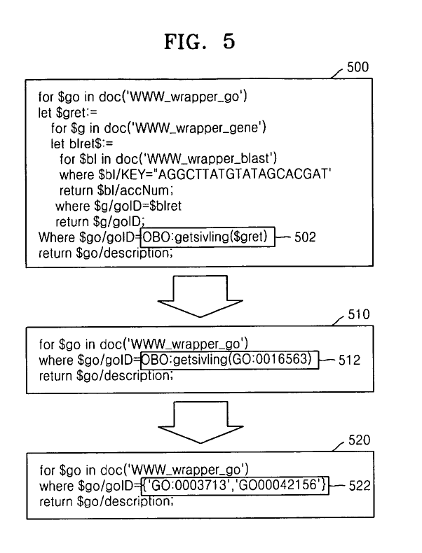

FIG. 5 is a view for explaining a gene-ontology-based XQuery query extension method according to an embodiment of the present invention. The query extension method illustrated in FIG. 5 is based on the ontology-based query extension rule table illustrated in FIG. 4.

In FIG. 5, a function in which OBO is defined is based on an ontology rule. All ontology-related queries must declare the corresponding rules in advance. The declared rules have compatibility with the ontology meta information 257 illustrated in FIG. 2.

An XQuery query of a W3C consotium declared by a user includes the ontology function proposed in the present invention. The content declared in the ontology function is to fetch siblings of the same layer if the siblings exist.

A user query is parsed until an ontology function is found, while being processed, and is subjected to general query processing. If an ontology function is found, an ontology calculation is performed, using values assigned as parameters to the ontology function in the previous process.

An ontology query to which parameter values are assigned is processed by an ontology management unit, and is substituted as the processed result value of the ontology function in an area where the ontology function is located in the previous query. That is, actual values for conceptually similar siblings are fetched to the corresponding values of information defined in the ‘gene-ontology consotium’, through ontology, so that the ontology query is extended and the corresponding values are substituted for the actual values. The extended query is converted into a general XQuery which can be continuously processed in a query processor.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, a biology information integration system which creates an integrated view, using a specification language with respect to various heterogeneous databases distributed on a network, and which provides a query in real time, is developed, thereby providing an environment in which data is actively integrated and manipulated. By using XQuery which is a standardized query language, users can easily use the integration system. Also, various queries can be implemented through ontology-based concept-based query extension capable of introducing a concept.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An information query extension system comprising:
a query processor receiving a query for desired information, from a user, and classifying the query into a local query for each of a plurality of distributed information databases;
a wrapper management unit managing at least one base wrapper for executing the local query and transferring the executed local query result to the query processor; and
an ontology management unit classifying an ontology processing query if the ontology processing query exists in the query, transferring the classified ontology processing query to the at least one base wrapper, receiving an executed local query result of the at least one base wrapper from the wrapper management unit, and reflecting the query executed result with the query.

2. The information query extension system of claim 1, wherein the ontology management unit classifies the query through parsing, stores the classified query in a parse tree, searches for respective items of the parse tree, drives an ontology wrapper, and transfers the classified query to the ontology wrapper if an ontology function exists.

3. The information query extension system of claim 1, wherein the ontology management unit includes information search query extension for fetching base information of ontology.

4. The information query extension system of claim 1, wherein the ontology management unit includes query extension through path searching extended using layer information.

5. The information query extension system of claim 1, wherein the ontology management unit includes query extension through cross-reference control of relationship between information.

6. The information query extension system of claim 1, wherein the ontology management unit includes inference-type query extension for implementing functions of an intersection and a union of information on the ontology.

7. An information query extension method comprising:
(a) receiving a query for desired information from a user and classifying the query into a local query for each of a plurality of distributed information databases;
(b) executing the classified local query using at least one base wrapper; and
(c) if an ontology processed query exists in the query, classifying the ontology processed query, transferring the classified query to the at least one base wrapper, and reflecting the executed query result of the at least one base wrapper with the query.

8. The information query extension method of claim 7, wherein (c) classifies the query through parsing, stores the classified query in a parse tree, searches for respective items of the parse tree, and drives an ontology wrapper and transfers the query to the base wrapper if the ontology function exists.

9. The information query extension method of claim 7, wherein the ontology processing query comprises: information search query extension for fetching base information of ontology; query extension through path searching extended using layer information; query extension through cross-reference control of relationship between information; and inference-type query extension for implementing functions of an intersection and a union of information on the ontology.
